(19) United States
(12) Patent Application Publication
(10) Pub. No.: US 2013/0308524 A1
(43) Pub. Date: Nov. 21, 2013

(54) DISTRIBUTED INTERFERENCE MANAGEMENT ALGORITHM

(71) Applicants: Saurabh Tavildar, Jersey City, NJ (US); Junyi Li, Chester, CA (US); Thomas J. Richardson, South Orange, NJ (US); Nilesh N. Khude, Bridgewater, NJ (US)

(72) Inventors: Saurabh Tavildar, Jersey City, NJ (US); Junyi Li, Chester, CA (US); Thomas J. Richardson, South Orange, NJ (US); Nilesh N. Khude, Bridgewater, NJ (US)

(73) Assignee: QUALCOMM Incorporated, San Diego, CA (US)

(21) Appl. No.: 13/471,690

(22) Filed: May 15, 2012

(51) Int. Cl. H04W 48/08; H04W 52/24

(52) U.S. Cl. 370/328

(57) ABSTRACT

A method, a computer program product, and an apparatus are provided. In a first configuration, an AP receives a transmission request from a UE in a communication link with the AP. The AP determines whether to yield a transmission request response to the transmission request based on one or more transmission requests received from at least one communication link with at least one other AP, but not from UEs in communication links with the AP. In a second configuration, an AP receives a transmission request response from a UE in a communication link with the AP. The AP determines whether to yield a data transmission to the UE based on one or more transmission requests responses received from at least one communication link with at least one other AP, but not from UEs in communication links with the AP.

### BACKGROUND

1. Field

The present disclosure relates generally to communication systems, and more particularly, to a distributed interference management algorithm.

2. Background

In a time division duplex (TDD) synchronous access network with a femto only deployment, the interference management and scheduling constraints are different than in a cellular network due to unplanned deployments of access points (APs), restricted association of user equipment (UE) to APs, bursty traffic due to lack of statistical multiplexing, etc. Because of these differences, APs should coordinate the scheduling of links. In access networks, UE-AP links may share a common node, i.e., the AP to which the UEs are associated. The UE-AP links sharing a common AP are referred to as sibling links. The link scheduling algorithm used in ad hoc peer to peer networks may be inefficient for access networks. The inefficiency arises as the link scheduling algorithms in peer to peer networks are agnostic to the fact that only one sibling link can be scheduled in a slot/frame. Accordingly, if all the sibling links participate in link scheduling, cascade yielding (a phenomenon in which a link yields its transmission opportunity to a link that has yielded to some other link) may be unnecessarily increased. As such, an improved link scheduling algorithm is needed for access networks.

### SUMMARY

In an aspect of the disclosure, a method, computer program product, and apparatus are provided. The apparatus may be an AP. The AP receives a transmission request from a UE in a communication link with the AP. The transmission request is for receiving a data transmission in uplink (UL) from the UE. The AP determines whether to transmit or to yield a transmission request response to the transmission request based on one or more transmission requests received from at least one communication link with at least one other AP, but not from UEs in communication links with the AP.

In an aspect of the disclosure, a method, computer program product, and apparatus are provided. The apparatus may be an AP. The AP receives a transmission request response from a UE in a communication link with the AP. The transmission request response is in response to a transmission request for sending a data transmission in downlink (DL) to the UE. The AP determines whether to yield the data transmission to the UE based on one or more transmission requests responses received from at least one communication link with at least one other AP, but not from UEs in communication links with the AP.

In an aspect of the disclosure, a method, computer program product, and apparatus are provided. The apparatus may be an UE. The UE receives a transmission request from an AP. The transmission request is for receiving a data transmission in DL from the AP. The UE determines whether to yield a transmission request response to the transmission request based on one or more transmission requests received from at least one communication link with at least one other AP, but not from communication links with the AP.

### BRIEF DESCRIPTION OF THE DRAWINGS

FIG. 1 is a drawing of a wireless peer-to-peer communications system.

FIG. 2 is a diagram illustrating an exemplary time structure for peer-to-peer communication between the wireless devices.

FIG. 3 is a diagram illustrating the channels in each frame of superframes in one grandframe.

FIG. 4 is a diagram illustrating an operation timeline of a traffic channel slot and a structure of connection scheduling.

FIG. 5 is a diagram illustrating a structure of a data segment.

FIG. 6A is a first diagram for illustrating a connection scheduling signaling scheme for the wireless devices.

FIG. 6B is a second diagram for illustrating a connection scheduling signaling scheme for the wireless devices.

FIG. 7 includes diagrams for illustrating an exemplary method.

FIG. 8 is a flow chart of a first method of wireless communication.

FIG. 9 is a flow chart of a second method of wireless communication.

FIG. 10 is a flow chart of a third method of wireless communication.

FIG. 11 is a conceptual data flow diagram illustrating the data flow between different modules/means/components in an exemplary AP apparatus.

FIG. 12 is a diagram illustrating an example of a hardware implementation for an AP apparatus employing a processing system.

FIG. 13 is a conceptual data flow diagram illustrating the data flow between different modules/means/components in an exemplary UE apparatus.

FIG. 14 is a diagram illustrating an example of a hardware implementation for a UE apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

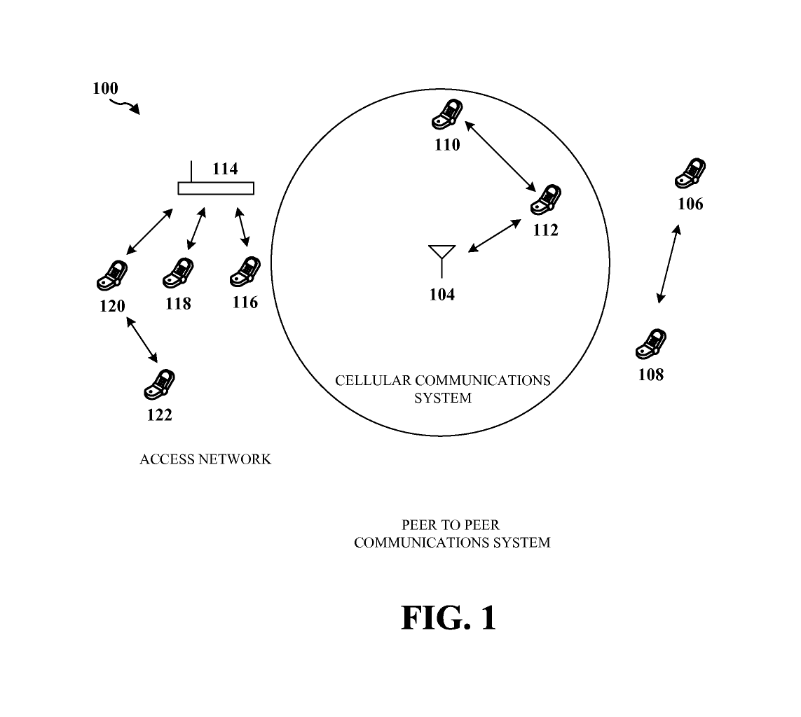

FIG. 1 is a drawing of an exemplary peer-to-peer communications system 100. The peer-to-peer communications system 100 includes a plurality of wireless devices 106, 108, 110, 112, 116, 118, 120, 122. The peer-to-peer communications system 100 may overlap with a wireless access network. In addition, the peer-to-peer communications system 100 may overlap with a cellular communications system, such as for example, a wireless wide area network (WWAN). Some of the wireless devices 116, 118, 120, 122 may communicate together in peer-to-peer communication, some may communicate with the AP 114, and some may do both. For example, as shown in FIG. 1, the wireless devices 116, 118, 120 are communicating with the AP 114 and the wireless devices 120, 122 are in peer-to-peer communication. Some of the wireless devices 106, 108, 110, 112 may communicate together in peer-to-peer communication, some may communicate with the base station 104, and some may do both. For example, as shown in FIG. 1, the wireless devices 106, 108 are in peer-to-peer communication and the wireless devices 110, 112 are in peer-to-peer communication. The wireless device 112 is also communicating with the base station 104.

The wireless device may alternatively be referred to by those skilled in the art as a UE, a mobile station, a subscriber station, a mobile unit, a subscriber unit, a wireless unit, a wireless node, a remote unit, a mobile device, a wireless communication device, a remote device, a mobile subscriber station, an access terminal, a mobile terminal, a wireless terminal, a remote terminal, a handset, a user agent, a mobile client, a client, or some other suitable terminology. The base station may alternatively be referred to by those skilled in the art as an access point, a base transceiver station, a radio base station, a radio transceiver, a transceiver function, a basic service set (BSS), an extended service set (ESS), a Node B, an evolved Node B, or some other suitable terminology.

The exemplary methods and apparatuses discussed infra are applicable to any of a variety of wireless peer-to-peer communications systems, such as for example, a wireless peer-to-peer communication system based on FlashLinQ, WiMedia, Bluetooth, ZigBee, or Wi-Fi based on the IEEE 802.11 standard. To simplify the discussion, the exemplary methods and apparatus are discussed within the context of FlashLinQ. However, one of ordinary skill in the art would understand that the exemplary methods and apparatuses are applicable more generally to a variety of other wireless peer-to-peer communication systems.

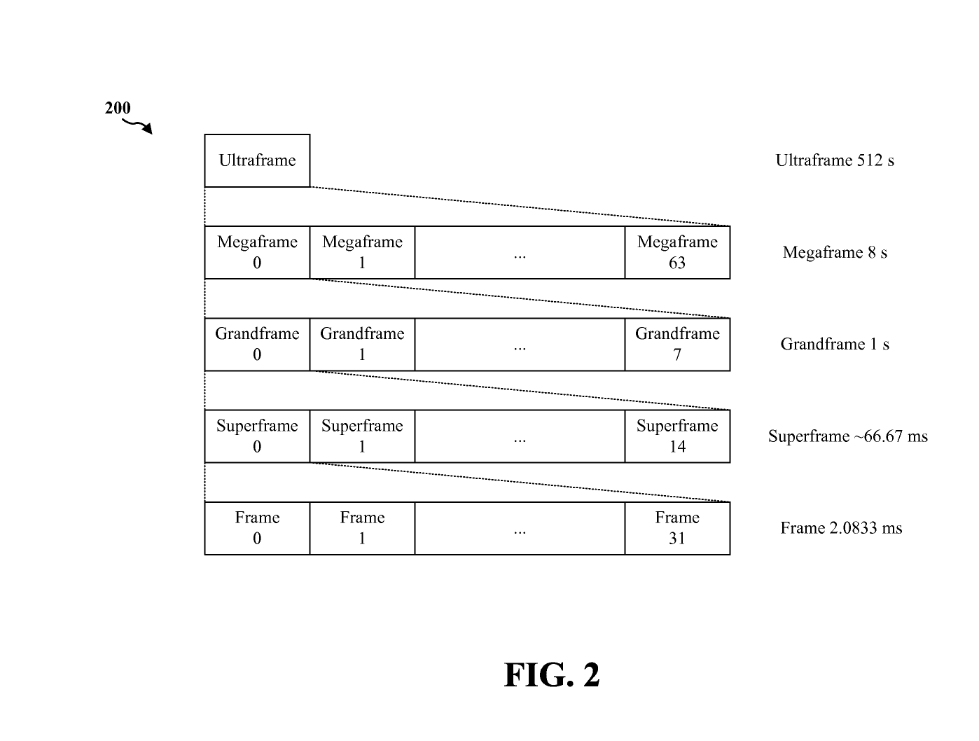

FIG. 2 is a diagram 200 illustrating an exemplary time structure for peer-to-peer communication between the wireless devices. An ultraframe is 512 seconds and includes 64 megaframes. Each megaframe is eight seconds and includes eight grandframes. Each grandframe is one second and includes 15 superframes. Each superframe is approximately 66.67 ms and includes 32 frames. Each frame is 2.0833 ms.

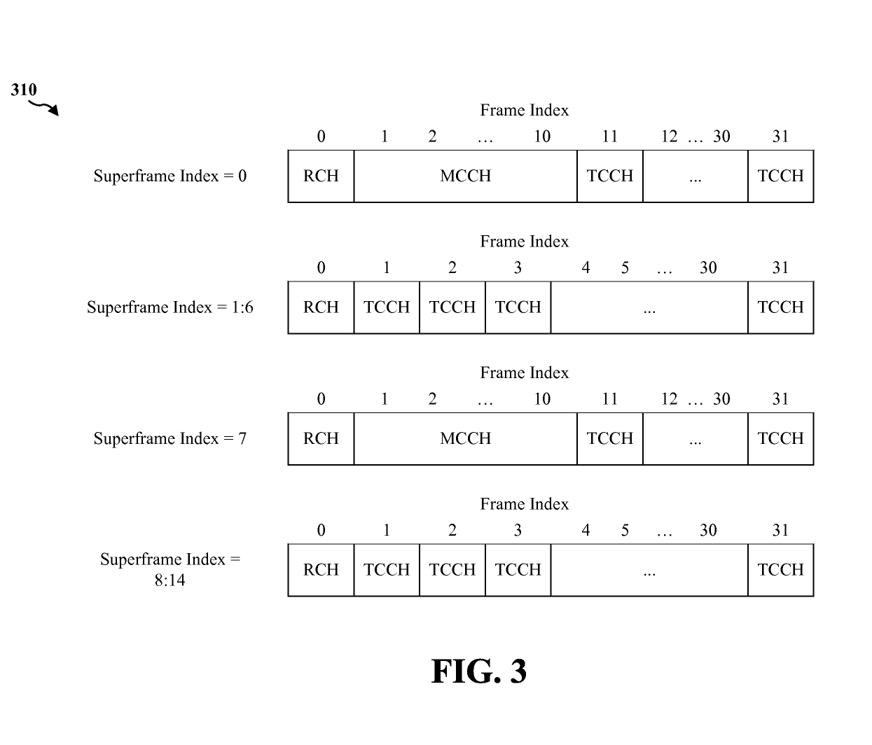

FIG. 3 is a diagram 310 illustrating the channels in each frame of superframes in one grandframe. In a first superframe (with index 0), frame 0 is a reserved channel (RCH), frames 1-10 are each a miscellaneous channel (MCCH), and frames 11-31 are each a traffic channel (TCCH). In the 2^{nd} through 7^{th} superframes (with index 1:6), frame 0 is a RCH and frames 1-31 are each a TCCH. In an 8^{th} superframe (with index 7), frame 0 is a RCH, frames 1-10 are each a MCCH, and frames 11-31 are each a TCCH. In the 9^{th} through 15^{th} superframes (with index 8:14), frame 0 is a RCH and frames 1-31 are each a TCCH. The MCCH of superframe index 0 includes a secondary timing synchronization channel, a peer discovery channel, a peer page channel, and a reserved slot. The MCCH of superframe index 7 includes a peer page channel and reserved slots. The TCCH includes connection scheduling, a pilot, channel quality indicator (CQI) feedback, a data segment, and an acknowledgement (ACK).

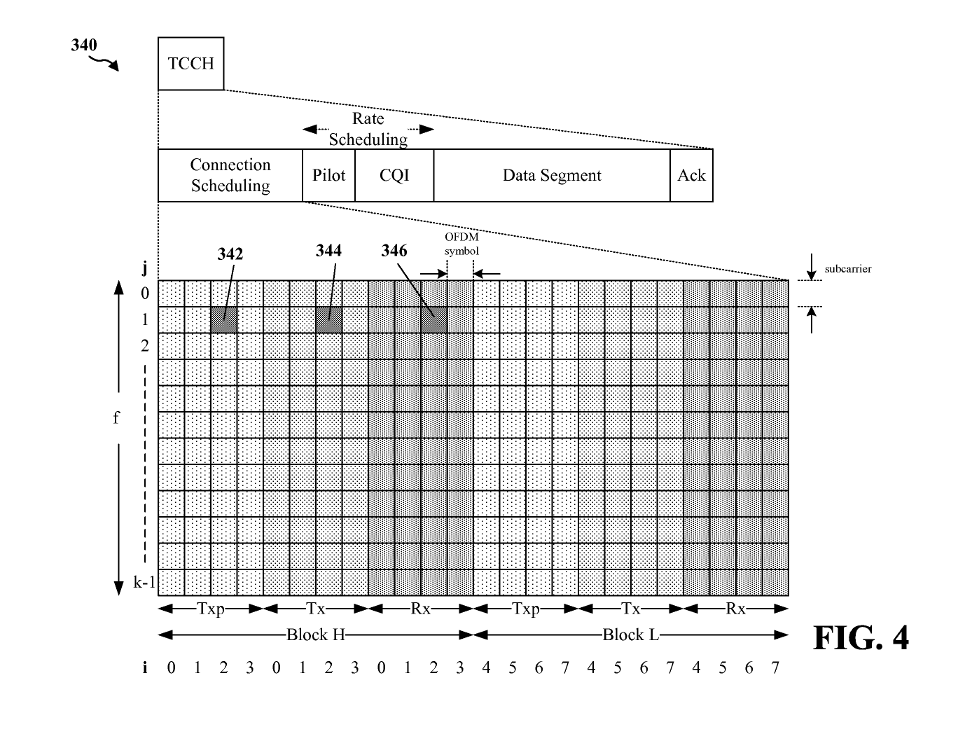

FIG. 4 is a diagram 340 illustrating an operation timeline of a TCCH slot and a structure of connection scheduling. As shown in FIG. 4, a TCCH slot includes four subchannels: connection scheduling, rate scheduling, data segment, and ACK. The rate scheduling subchannel includes a pilot segment and a CQI segment. The ACK subchannel is for transmitting an ACK or negative ACK (NACK) in response to data received in the data segment subchannel. The connection scheduling subchannel includes two blocks, a higher priority Block H and a lower priority Block L. Each of Block H and Block L contains a plurality of resource elements, i.e., a plurality of subcarriers in the frequency domain and OFDM symbols in the time domain. Each of Block H and Block L spans the plurality of subcarriers and includes four OFDM symbols in a Txp-block, four OFDM symbols in a Tx-block, and four OFDM symbols in an Rx-block. One resource element (or tone) corresponds to one subcarrier and one OFDM symbol.

Each link has a locally unique identifier called a connection ID (CID). Based on the CID, for a particular TCCH slot, wireless devices in a link are allocated a resource element in the same respective OFDM symbol position in each of the Txp-block, the Tx-block, and the Rx-block at a particular subcarrier and within Block H or Block L. For example, in a particular TCCH slot, a link with CID=4 may be allocated the resource element 342 in the Txp-block of Block H, the resource element 344 in the Tx-block of Block H, and the resource element 346 in the Rx-block of Block H for transmitting/receiving a scheduling control signal. A transmit request signal in the Tx-block is transmitted with a power equal to a power for transmitting the data segment. A transmit request response signal in the Rx-block is transmitted with a power proportional to an inverse of the power of the received transmit request signal. The allocated trio of resource elements for the Txp-block, Tx-block, and Rx-block vary with respect to the subcarrier (e.g., k different subcarriers) and the respective OFDM symbol in each TCCH slot (e.g., 8 different OFDM symbols—4 in the Block H and 4 in the Block L).

The trio of resource elements allocated to a link dictates the medium access priority of the link. For example, the trio of resource elements 342, 344, 346 corresponds to i=2 and j=1. The medium access priority is equal to ki+j+1, where i is the respective OFDM symbol in each of the Txp, Tx, and Rx subblocks, j is the subcarrier, and k is the number of subcarriers. Accordingly, assuming k=28, the resource elements 342, 344, 346 correspond to a medium access priority of 58.

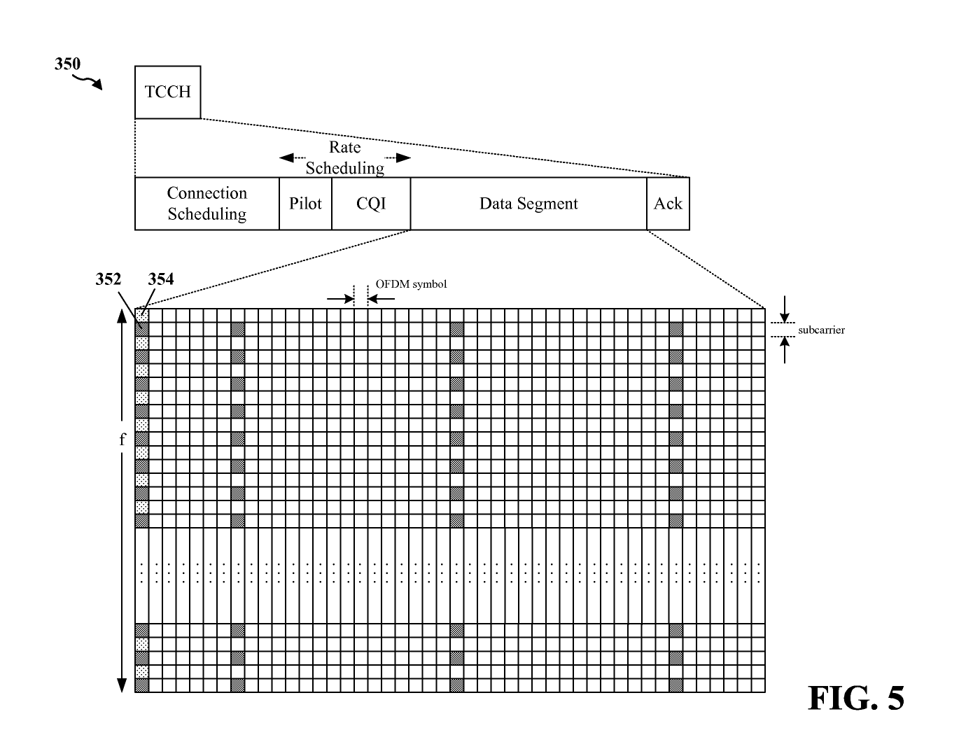

FIG. 5 is a diagram 350 illustrating a structure of the data segment. The data segment contains a plurality of resource elements spanning a plurality of subcarriers in the frequency domain and OFDM symbols in the time domain. Some of the resource elements in the data segment, such as resource element 354, may carry rate indicator information regarding the coding and/or modulation used for the data segment. Other resource elements in the data segment, such as resource element 352, may carry a pilot to allow for estimating the channel for demodulation and decoding.

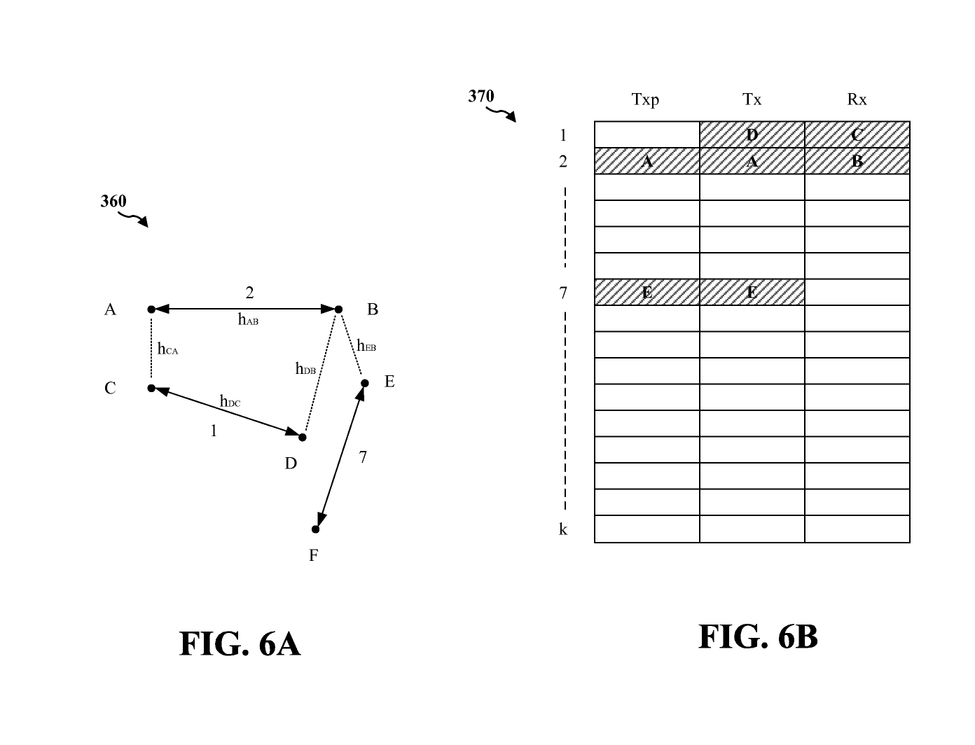

FIG. 6A is a first diagram 360 for illustrating an exemplary connection scheduling signaling scheme for the wireless devices. As shown in FIG. 6A, wireless device A is communicating with wireless device B, wireless device C is communicating with wireless device D, and wireless device E is communicating with wireless device F. The wireless device A is assumed to have transmit priority over the wireless device B, the wireless device C is assumed to have transmit priority over the wireless device D, and the wireless device E is assumed to have transmit priority over the wireless device F. Each of the links has a different medium access priority depending on the particular slot for communication. For the particular slot for communication, link 1 (A, B) is assumed to have a medium access priority of 2, link 2 (C, D) is assumed to have a medium access priority of 1, and link 3 (E, F) is assumed to have a medium access priority of 7.

FIG. 6B is a second diagram 370 for illustrating an exemplary connection scheduling signaling scheme for the wireless devices. FIG. 6B shows connection scheduling resources of first respective OFDM symbols (i=0, see FIG. 4) of Txp, Tx, and Rx subblocks in Block H (corresponding to medium access priorities 1 through k) in the connection scheduling subchannel. The connection scheduling resources include a plurality of subcarriers, each of the subcarriers corresponding to one of k frequency bands. Each of the frequency bands corresponds to a particular medium access priority. One block in the connection scheduling resources is split into three subblocks/phases: Txp, Tx, and Rx. The Txp-block is used by the node with transmit priority in the link to indicate whether the node with transmit priority will act as a transmitter or a receiver. If the node with transmit priority transmits on the allocated OFDM symbol in the Txp-block, the node with transmit priority indicates to the node without transmit priority an intent to act as a transmitter. If the node with transmit priority does not transmit on the allocated OFDM symbol in the Txp-block, the node with transmit priority indicates to the node without transmit priority an intent to act as a receiver. The Tx-block is used by potential transmitters to make a request to be scheduled. The transmitter transmits a direct power signal on the allocated OFDM symbol in the Tx-block at a power equal to a power used for the traffic channel (i.e., a power for transmitting the data segment). Each potential receiver listens to the tones in the Tx-blocks, compares the received power on each of the Tx-blocks to the received power on the Tx-block allocated to the transmitter of its own link, and determines whether to Rx-yield based on its own link medium access priority relative to other link medium access priorities and the comparison.

For example, assume the nodes A, D, and E transmit a transmit request signal in the Tx-block at a power equal to P_{A}, P_{D}, and P_{E}, respectively. The node B receives the transmit request signal from the node A at a power equal to P_{A}|h_{AB}|², where |h_{AB}|² is the path loss between the node A and the node B. The node B receives the transmit request signal from the node D with a power equal to P_{D}|h_{EB}|², where |h_{EB}|² is the path loss between the node D and the node B. The node B receives the transmit request signal from the node E with a power equal to P_{E}|h_{EB}|², where |h_{EB}|² is the path loss between the node E and the node B. The node B compares the power of the received transmit request signal from the node A divided by the sum of the powers of the received transmit request signals from other nodes with a higher priority to a threshold in order to determine whether to Rx-yield. The node B does not Rx-yield if the node B expects a reasonable SIR if scheduled. That is, the node B Rx-yields unless P_{A}|h_{AB}|²/P_{D}|h_{DB}|²>γ_{RX}, where γ_{Rx} is the threshold (e.g., 9 dB).

The Rx-block is used by the potential receivers. If the receiver chooses to Rx-yield, the receiver does not transmit in the allocated OFDM symbol in the Rx-block; otherwise, the receiver transmits an inverse echo power signal in the allocated OFDM symbol in the Rx-block at a power proportional to an inverse of the power of the received direct power signal from the transmitter of its own link. All of the transmitters listen to the tones in the Rx-block to determine whether to Tx-yield transmission of the data segment.

For example, the node C, having received the transmit request signal from the node D at a power equal to P_{D}|h_{Dc}|², transmits a transmit request response signal in the Rx-block at a power equal to K/P_{D}|h_{DC}|², where |h_{DC}|² is the path loss between the node D and the node C, and K is a constant known to all nodes. The node A receives the transmit request response signal from the node C at a power equal to K|h_{CA}|²/P_{D}|h_{DC}|², where |h_{CA}|² is the path loss between the node C and the node A. The node A Tx-yields if the node A would cause too much interference to the node C. That is, the node A Tx-yields unless P_{D}|h_{DC}|²/P_{A}|h_{CA}|²>γ_{TX}, where γ_{TX} is a threshold (e.g., 9 dB).

The connection scheduling signaling scheme is best described in conjunction with an example. The node C has no data to transmit and does not transmit in the Txp-block for medium access priority 1, the node A has data to transmit and transmits in the Txp-block for medium access priority 2, and the node E has data to transmit and transmits in the Txp-block for medium access priority 7. The node D has data to transmit and transmits in the Tx-block for medium access priority 1, the node A transmits in the Tx-block for medium access priority 2, and the node E transmits in the Tx-block for medium access priority 7. The node C listens to the tones in the Tx-blocks and determines to transmit in the Rx-block for medium access priority 1, as the node C has the highest priority. The node B listens to the tones in the Tx-blocks, determines that its link would not interfere with link 2, which has a higher medium access priority, and transmits in the Rx-block for medium access priority 2. The node F listens to the tones in the Tx-blocks, determines that its link would interfere with link 1 and/or link 2, both of which have a higher medium access priority, and Rx-yields by not transmitting in the Rx-block for medium access priority 7. Subsequently, both D and A listen to the tones in the Rx blocks to determine whether to transmit the data. Because D has a higher link medium access priority than A, D transmits its data. A will Tx-yield transmission of the data if A determines that its transmission would interfere with the transmission from D.

The aforementioned connection scheduling algorithm may be inefficient with respect to sibling links and may result in unnecessary cascaded yielding. As an example of cascaded yielding, consider a scenario in which a high priority UE A and a low priority UE C can transmit concurrently in a particular slot/frame without interference, but the low priority UE C yields to a higher priority UE B, which itself yields to the high priority UE A. As a result of cascaded yielding, only the UE A may end of transmitting in a particular slot/frame rather than both UEs A, C. Exemplary methods of a more efficient connection scheduling algorithm that takes into account sibling links is provided infra.

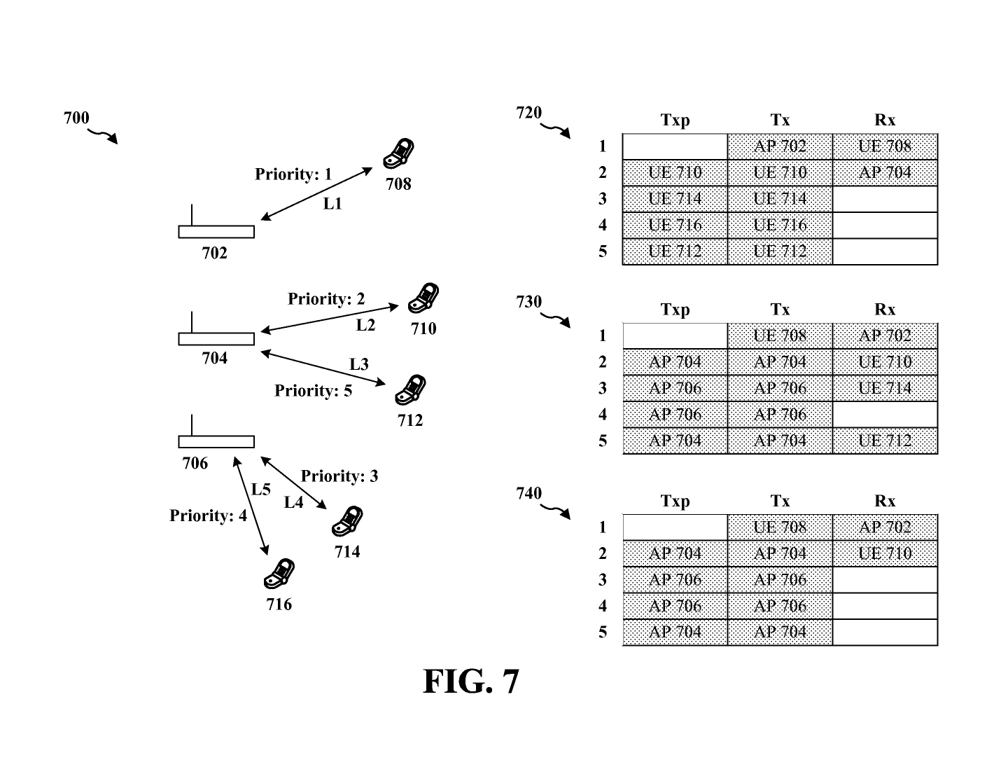

FIG. 7 includes diagrams 700, 720, 730, 740 for illustrating an exemplary method. As shown in FIG. 7, the AP 702 and the UE 708 are in a communication link L1, the AP 704 and the UE 710 are in a communication link L2, the AP 704 and the UE 712 are in a communication link L3, the AP 706 and the UE 714 are in a communication link L4, and the AP 706 and the UE 716 are in a communication link L5. To illustrate the exemplary method, for a particular slot/frame, the link L1 is assumed to have a priority of 1, the link L2 is assumed to have a priority of 2, the link L3 is assumed to have a priority of 5, the link L4 is assumed to have a priority of 3, and the link L5 is assumed to have a priority of 4, with the priority 1 being the highest and the priority 5 being the lowest. The priorities for the links may change (i.e., hop around) for subsequent slots/frames.

For the connection scheduling resources 720, assume the UEs 708-716 have transmit priority over the APs 702-706 for a particular slot/frame. The UEs 710-716 each indicate in the Txp-block an intent to act as the transmitter. The UE 708, without data to transmit, indicates an intent to act as the receiver by not transmitting in the Txp-block. The UEs 710, 712 each transmit a transmission request in the Tx-block. The AP 704 receives the transmission requests from the UEs 710, 712. The AP 704 also receives (overhears) the transmission requests broadcasted from the AP 702, the UE 714, and the UE 716. As discussed supra in relation to FIGS. 6A, 6B, the AP 704 determines whether to Rx-yield for a particular link based on higher priority signals received from other UEs/APs. However, in the exemplary methods, when determining whether to Rx-yield for a particular link, the AP 704 does not take into account sibling links. In addition, when determining whether to Rx-yield for a particular link, the AP 704 may take into account only the strongest interfering link of a set of non-sibling links associated with a particular AP. The AP 704 may take into account only the strongest interfering link associated with a particular AP because the particular AP may only schedule one link per slot/frame. Furthermore, the AP 704 may determine whether to Rx-yield for a particular link based on a sum of the strongest interfering links associated with other APs.

For example, the AP 704 determines whether to Rx-yield for link L2 based on the received power of the transmission request from the AP 702 in link L1, as link L1 has a higher priority. When determining whether to Rx-yield for link L2, which has a priority of 2, the AP 704 does not take into account the sibling link L3 and does not take into account the links L4 and L5, each of which have a lower priority. As shown in the connection scheduling resources 720, the AP 704 determines not to Rx-yield for link L2 and therefore transmits a transmission request response in the Rx-block.

The AP 704 determines whether to Rx-yield for link L3 based on the received power of the transmission request from link L1, which has a higher priority, and the transmission request from the strongest interfering link of links L4, L5, as links L4, L5 are part of the same network and have a higher priority than link L3. If one of link L4 or link L5 had a lower priority, then the AP 704 would take into account only the higher priority link. For example, if link L4 had a lower priority and L5 a higher priority, then the AP 704 would take into account the received power of the transmission requests from link L1 and link L5. Assume for this example that both link L4 and link L5 have a higher priority and that link L4 is the strongest interfering link of the links L4, L5. The AP 704 may then determine whether to Rx-yield for link L3 based on a sum of the received power of the transmission request from link L1 and the received power of the transmission request from link L4. As shown in the connection scheduling resources 720, the AP 704 determines to Rx-yield for link L3 and therefore refrains from transmitting a transmission request response in the Rx-block.

If the AP 704 determines not to Rx-yield for both link L2 and link L3 (i.e., that the interference levels are acceptable for both link L2 and link L3), then the AP 704 will select only one link to transmit a transmission request response. The AP 704 may determine whether to transmit the transmission request response to the UE 710 or the UE 712 based on priorities of the respective transmission requests, a quality of service (QoS) subscribed by each of the UE 710 and the UE 712, and/or the estimated rate of the communication link with the UE 710 and the UE 712. For example, the AP 704 may determine to transmit the transmission request response to the UE 710 and not to the UE 712 because the transmission request of the UE 710 has a higher priority (priority of 2) than the transmission request of the UE 712 (priority of 5). For another example, the AP 704 may determine to transmit the transmission request response to the UE with the highest subscribed QoS. That is, if the user of the UE 712 pays for a higher QoS than the user of the UE 710, the AP 704 may determine to transmit the transmission request response to the UE 712 rather than the UE 710. For yet another example, the AP 704 may determine to transmit the transmission request response to the UE with the highest estimated rate in order to maximize the data transfer rate per slot/frame among its communication links. For yet another example, the AP 704 may determine to which UE to transmit the transmission request response based on any combination or weighted combination of priority, QoS, and estimated rate.

For the connection scheduling resources 730, assume the APs 702-706 have transmit priority over the UEs 708-716 for a particular slot/frame. The APs 704, 706 each indicate in the Txp-block an intent to act as the transmitter. The AP 702, without data to transmit, indicates an intent to act as the receiver by not transmitting in the Txp-block. The AP 704 determines a path loss to each of the UEs 710, 712. Based on the determined path loss to the UE 710, the AP 704 determines a transmit power for transmitting the transmission request to the UE 710. Based on the determined path loss to the UE 712, the AP 704 determines a transmit power for transmitting the transmission request to the UE 712. The UEs 710, 712 receive the transmission requests, determine not to Rx-yield, and transmit a transmission request response to the AP 704. The AP 704 receives the transmission request responses from the UEs 710, 712. The AP 704 also receives (overhears) the transmission request responses broadcasted from the UE 714 and from the AP 702. The AP 704 determines whether to Tx-yield a data transmission to the UE 710 based on the received power of the transmission request response from link L1, as link L1 has a higher priority. When determining whether to Tx-yield the data transmission to the UE 710, the AP 704 does not take into account the received power of the transmission request response from link L3, as link L3 is a sibling link. The AP 704 determines whether to Tx-yield a data transmission the UE 712 based on the received power of the transmission request response from link L1, as link L1 has a higher priority, and the received power of the transmission request response from link L4, as link L4 has a higher priority. When determining whether to Tx-yield the data transmission to the UE 712, the AP 704 does not take into account the received power of the transmission request response from link L2, as link L2 is a sibling link.

If the AP 704 determines not to Tx-yield data transmissions to the UEs 710, 712, the AP 704 determines whether to transmit a data transmission to the UE 710 or the UE 712. The AP 704 may determine whether to transmit a data transmission to the UE 710 or the UE 712 based on the priorities of the respective transmission request responses from the UEs 710, 712, a QoS subscribed by each of the UEs 710, 712, and/or an estimated rate of the communication links with the UEs 710, 712.

For the connection scheduling resources 740, assume the APs 702-706 have transmit priority over the UEs 708-716 for a particular slot/frame. The APs 704, 706 each indicate in the Txp-block an intent to act as the transmitter. The AP 702, without data to transmit, indicates an intent to act as the receiver by not transmitting in the Txp-block. The APs 704, 706 each transmit a transmission request in the Tx-block. The UE 710 receives the transmission request from the AP 704. The UE 710 also receives (overhears) the transmission requests broadcasted from the AP 706 and the transmission request broadcasted from the UE 708. The UE 710 determines whether to Rx-yield based on the received power of the transmission request from the UE 708 in link L1, as link L1 has a higher priority. When determining whether to Rx-yield, the UE 710 does not take into account the sibling link L3, and does not take into account the links L4 and L5, as links L4 and L5 have a lower priority than link L2. As shown in the connection scheduling resources 740, the UE 710 determines not to Rx-yield and therefore transmits a transmission request response in the Rx-block.

The UE 712 determines whether to Rx-yield based on the received power of the transmission request from link L1, which has a higher priority, and the transmission request from the strongest interfering link of links L4, L5, as links L4, L5 are part of the same network and have a higher priority than link L3. If one of link L4 or link L5 had a lower priority, then the UE 712 would take into account only the higher priority link. For example, if link L4 had a lower priority and L5 a higher priority, then the UE 712 would take into account the received power of the transmission requests from link L1 and link L5. Assume for this example that both link L4 and link L5 have a higher priority and that link L4 is the strongest interfering link of the links L4, L5. The UE 712 may then determine whether to Rx-yield based on a sum of the received power of the transmission request from link L1 and the received power of the transmission request from link L4. As shown in the connection scheduling resources 740, the UE 712 determines to Rx-yield and therefore refrains from transmitting a transmission request response in the Rx-block.

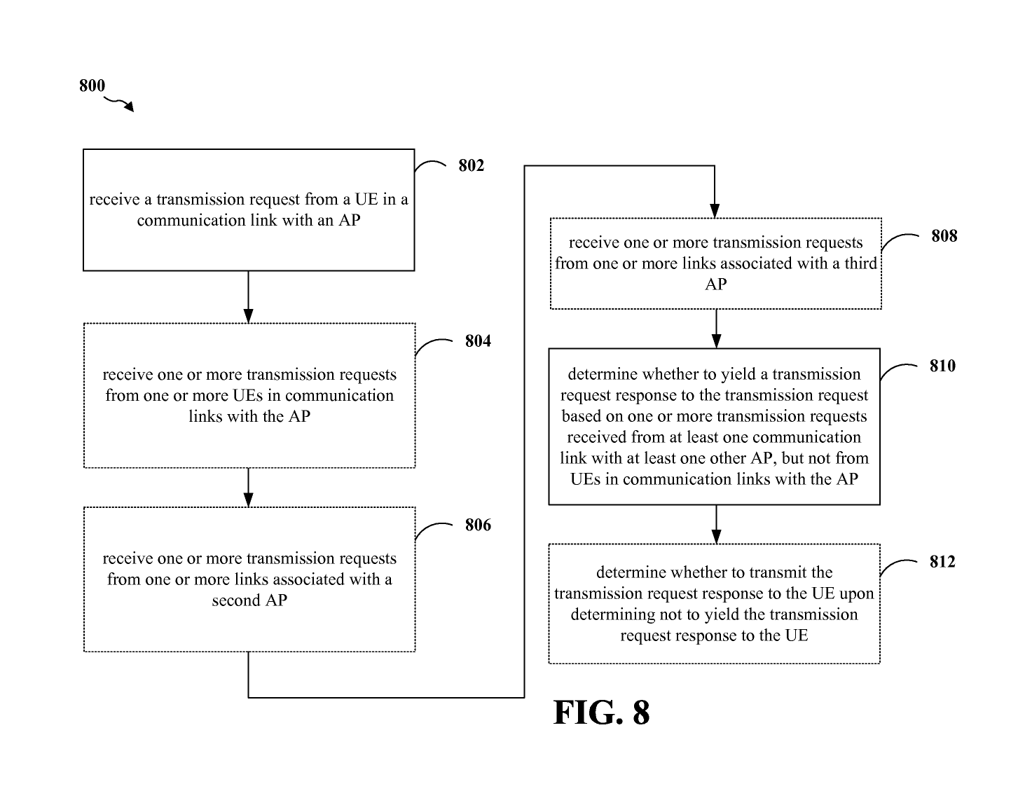

FIG. 8 is a flow chart 800 of a first method of wireless communication. The method may be performed by an AP in a UL mode. The steps in dotted lines are optional. In step 802, the AP receives a transmission request from a UE in a communication link with the AP. In step 804, the AP may receive one or more transmission requests from one or more UEs in communication links with the AP. In step 806, the AP may receive one or more transmission requests from one or more links associated with a second AP (i.e., second AP or UEs in communication links with the second AP). In step 808, the AP may receive one or more transmission requests from one or more links associated with a third AP (i.e., third AP or UEs in communication links with the third AP). In step 810, the AP determines whether to Rx-yield a transmission request response to the transmission request in step 802 based on one or more transmission requests received from at least one communication link with at least one other AP in steps 806, 808, but not from UEs in communication links with the AP in step 804.

In step 806, the AP may receive a second transmission request from a communication link with a second AP. In step 810, to determine whether to Rx-yield the transmission request response to the transmission request, the AP determines a priority of the transmission request and the second transmission request. If the priority of the second transmission request is higher than the priority of the transmission request, the determination by the AP whether to Rx-yield the transmission request response is based on the second transmission request when the second transmission request has a strongest received power of transmission requests received from links with the second AP that have higher priority than the priority of the transmission request. For example, referring to FIG. 7 (see connection scheduling resources 720), the AP 704 receives (overhears) a transmission request broadcasted from the UE 714. The transmission request from the UE 714 has a priority of 3 while the transmission request received from the UE 712 has a priority of 5. Assume the transmission request from the UE 714 has a stronger received power than the transmission request received (overheard) from the UE 716 (which has a priority of 4). Because the transmission request received from the UE 714 has a higher priority than the transmission request received from the UE 712 and because the transmission request received from the UE 714 has a strongest received power of transmission requests received from links with the AP 706 that have higher priority than the priority of the transmission request received from the UE 712, the AP 704 determines whether to Rx-yield the transmission request response to the transmission request from the UE 712 based on the transmission request received from the UE 714.

In step 806, the AP may receive a second transmission request and a third transmission request from communication links with the second AP. In step 810, to determine whether to Rx-yield the transmission request response to the transmission request, the AP determines whether priorities of the second and third transmission requests are higher than a priority of the transmission request. If the priorities of the second and third transmission requests are higher than the priority of the transmission request, the AP determines which of the second transmission request and the third transmission request has the strongest received power. The AP determines whether to Rx-yield the transmission request response based on one of the second transmission request or the third transmission request with the strongest received power. For example, referring to FIG. 7 (see connection scheduling resources 720), the AP 704 receives (overhears) a second transmission request broadcasted from the UE 714 and a third transmission request broadcasted from the UE 716. Both the UE 714 and the UE 716 are in a communication link with the AP 706. The AP 704 determines that the priority of the second transmission request (priority 3) and the third transmission request (priority 4) are greater than the priority of the transmission request (priority 5) from the UE 712. The AP 704 then determines which of the second transmission request and the third transmission request has a strongest received power. The AP 704 determines whether to Rx-yield the transmission request response to the transmission request from the UE 712 based on one of the second transmission request or the third transmission request with the strongest received power.

In step 808, the AP may receive a fourth transmission request from a communication link with a third AP. In step 810, to determine whether to Rx-yield the transmission request response to the transmission request, the AP determines whether a priority of the fourth transmission request is higher than a priority of the transmission request. If the priority of the fourth transmission request is higher than the priority of the transmission request, the AP may determine whether to Rx-yield the transmission request response based on a sum of a received power of the fourth transmission request and a strongest received power of the second transmission request or the third transmission request. For example, referring to FIG. 7 (see connection scheduling resources 720), the AP 704 receives (overhears) a second transmission request broadcasted from the UE 714, a third transmission request broadcasted from the UE 716, and a fourth transmission request broadcasted from the AP 702. The AP 704 determines whether to Rx-yield the transmission request response to the transmission request from the UE 712 based on a sum of a received power of the fourth transmission request from the AP 702 and a strongest received power of the second transmission request from the UE 714 or the third transmission request from the UE 716.

In step 804, the AP may receive a second transmission request from a second UE in a communication link with the AP. In step 810, the determination by the AP whether to Rx-yield the transmission request response to the transmission request of the UE is not based on the second transmission request. For example, referring to FIG. 7 (see connection scheduling resources 720), when determining whether to Rx-yield the transmission request response to the UE 712, the AP 704 does not take into account the transmission request received from the UE 710.

In step 812, the AP may determine whether to transmit the transmission request response to the UE upon determining not to Rx-yield the transmission request response to the UE. For example, referring to FIG. 7 (see connection scheduling resources 720), assume the AP 704 determines not to Rx-yield the transmission request response to the UE 710 and not to Rx-yield the transmission request response to the UE 712. The AP 704 will then determine whether to transmit the transmission request response to the UE 710 or the UE 712 (i.e., the AP 704 will select only one UE of the UE 710 and the UE 712 and transmit the transmission request response to the selected one UE). The AP 704 may make this determination based on priorities of the respective transmission requests, a QoS subscribed by each of the UEs 710, 712, and/or an estimated rate of each of the UEs 710, 712.

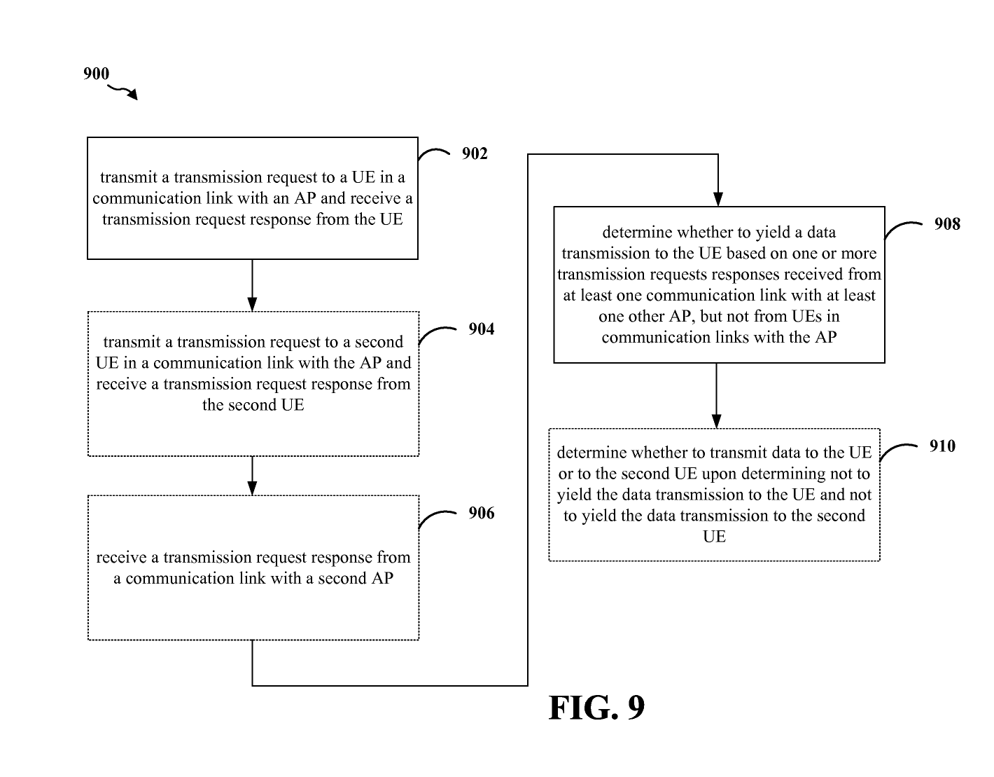

FIG. 9 is a flow chart 900 of a second method of wireless communication. The method may be performed by an AP in a DL mode. The steps in dotted lines are optional. In step 902, the AP transmits a transmission request to a UE in a communication link with the AP and receives a transmission request response from the UE. In step 908, the AP determines whether to Tx-yield a data transmission to the UE based on one or more transmission requests responses received from at least one communication link with at least one other AP, but not from UEs in communication links with the AP.

In step 904, the AP may transmit a second transmission request to a second UE in a communication link with the AP and receive a transmission request response from the second UE. In step 908, the AP does not take into account the second transmission request response when determining whether to Tx-yield the data transmission to the UE. The AP may determine a first transmit power based on a path loss to the UE, determine a second transmit power based on a path loss to the second UE, transmit the transmission request at the first transmit power, and transmit the second transmission request at the second transmit power. The first and second transmit powers may be different.

In step 910, the AP may determine whether to transmit data to the UE or to the second UE upon determining not to Tx-yield the data transmission to the UE and not to Tx-yield the data transmission to the second UE. The AP may make the determination whether to transmit the data to the UE or the second UE based on at least one of priorities of the respective transmission request responses, a QoS subscribed by each of the UE and the second UE, or an estimated rate of the communication link with the UE and the second UE.

In step 906, the AP may receive a transmission request response from a communication link with a second AP. If the received transmission request response has a higher priority than the transmission request response received from the UE, the AP determines whether to Tx-yield the data transmission based on the received transmission request response. For example, referring to FIG. 7 (see connection scheduling resources 730), the AP 704 transmits a transmission request to the UE 712 and receives a transmission request response from the UE 712 in response to the transmission request. The AP 704 transmits a transmission request to the UE 710 and receives a transmission request response from the UE 710 in response to the transmission request. The AP 704 also receives (overhears) transmission request responses broadcasted from the AP 702 and from the UE 714. The AP 704 determines whether to Tx-yield the data transmission to the UE 710 based on the transmission request response from the AP 702, as the transmission request response from the AP 702 has a higher priority than the transmission request response from the UE 710. The AP 704 determines whether to Tx-yield the data transmission to the UE 712 based on the transmission request responses from both the AP 702 and the UE 714, as both of these transmission request responses have a higher priority than the transmission request response from the UE 712. If the AP 704 determines not to Tx-yield the data transmissions to the UEs 710, 712, the AP 704 will select to transmit the data transmission to only one of the UEs 710, 712. For example, the AP 704 may select to transmit the data transmission to the UE 710, but not to the UE 712 because the transmission request response from the UE 710 has a higher priority than the transmission request response from the UE 712. The selection may be based on other factors, including a subscribed QoS for each of the UEs 710, 712 and/or an estimated rate for the data transmission.

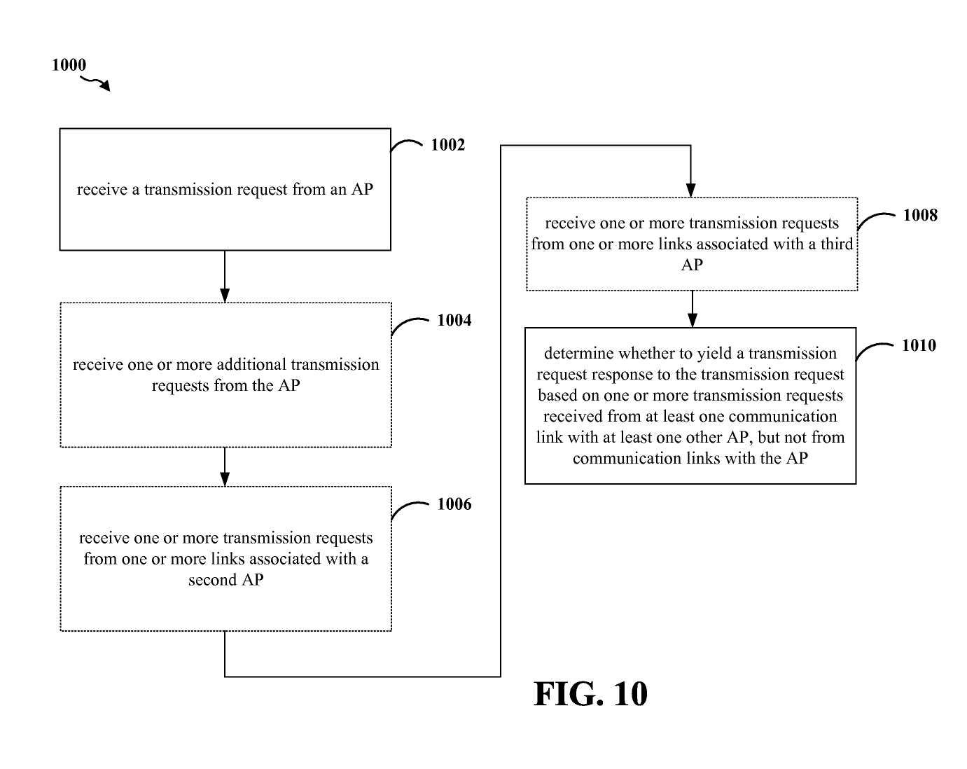

FIG. 10 is a flow chart 1000 of a third method of wireless communication. The method may be performed by a UE in a DL mode. The steps in dotted lines are optional. In step 1002, the UE receives a transmission request from an AP. In step 1010, the UE determines whether to Rx-yield a transmission request response to the transmission request based on one or more transmission requests received from at least one communication link with at least one other AP, but not from communication links with the AP.

In step 1004, the UE may receive a second transmission request from the AP. The second transmission request is transmitted by the AP for a second UE in a communication link with the AP. In step 1010, the UE does not take into account the received second transmission request when determining whether to Rx-yield the transmission request response to the AP.

In step 1006, the UE may receive a second transmission request from a communication link with a second AP. In step 1010, to determine whether to Rx-yield the transmission request response to the AP, the UE determines whether the priority of the second transmission request is higher than the priority of the transmission request. If the second transmission request has a higher priority than the transmission request from the AP and has the strongest received power of transmission requests received from links with the second AP, the UE determines whether to Rx-yield the transmission request response based on the second transmission request.

In step 1006, the UE may also receive a third transmission request from a communication link with the second AP. In step 1010, to determine whether to Rx-yield the transmission request response to the AP, the UE determines whether the priority of the third transmission request is higher than the priority of the transmission request. If the third transmission request has a higher priority than the transmission request from the AP, the UE determines which of the second transmission request and the third transmission request has a strongest received power. The UE determines whether to Rx-yield the transmission request response to the UE based on one of the second transmission request or the third transmission request with the strongest received power.

In step 1008, the UE may also receive a fourth transmission request from a communication link with a third AP. In step 1010, to determine whether to Rx-yield the transmission request response to the AP, the UE determines whether a priority of the fourth transmission request is higher than a priority of the transmission request. If the fourth transmission request has a higher priority than the transmission request, the UE determines whether to Rx-yield the transmission request response based on a sum of a received power of the fourth transmission request and a strongest received power of the second transmission request or the third transmission request.

For example, referring to FIG. 7 (see connection scheduling resources 740), the UE 712 receives a transmission request from the AP 704. The UE 712 also receives (overhears) the transmission requests broadcasted from the UE 708 to the AP 702, from the AP 704 to the UE 710, from the AP 706 to the UE 714, and from the AP 706 to the UE 716. The UE 712 determines whether to Rx-yield a transmission request response to the AP 704 based on the transmission request from the UE 708 and based on a transmission request with the strongest received power of one of the transmission request from the AP 706 to the UE 714 or the transmission request from the AP 706 to the UE 716.

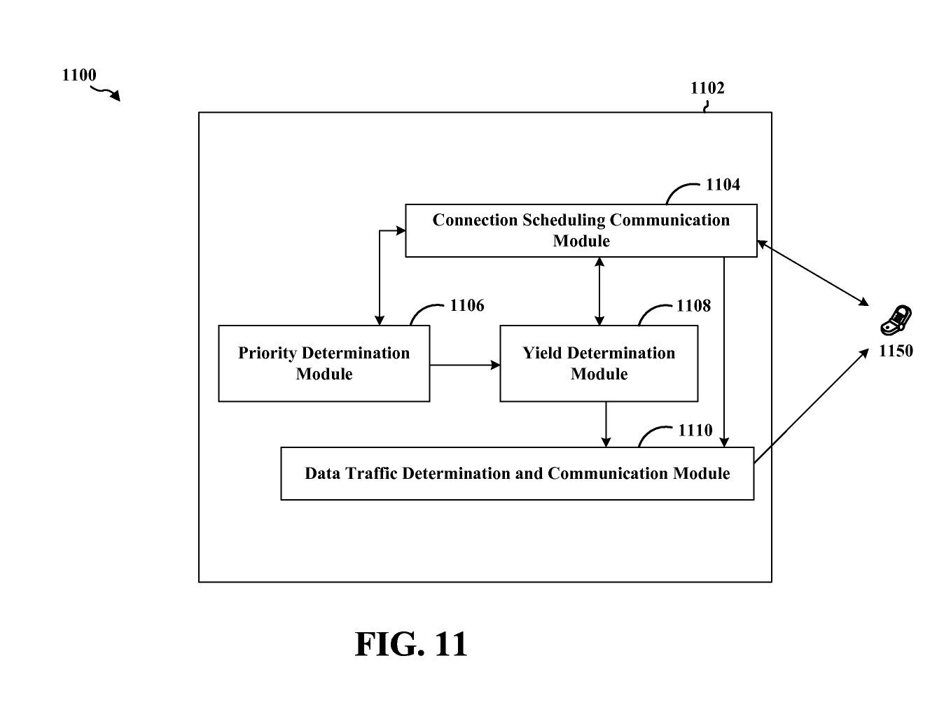

FIG. 11 is a conceptual data flow diagram 1100 illustrating the data flow between different modules/means/components in an exemplary AP apparatus 1102. The AP 1102 includes a connection scheduling communication module 1104, a priority determination module 1106, a yield determination module 1108, and a data traffic determination and communication module 1110. In a first embodiment, the connection scheduling communication module 1104 is configured to receive a transmission request from a UE 1150 in a communication link with the AP 1102. The yield determination module 1108 is configured to determine whether to Rx-yield a transmission request response to the transmission request based on one or more transmission requests received from at least one communication link with at least one other AP, but not from UEs in communication links with the AP 1102.

In one configuration, the priority determination module 1106 is configured to determine a priority of the transmission request. The connection scheduling communication module 1104 is configured to receive a second transmission request from a communication link with a second AP. The second AP is one of the at least one other AP. The priority determination module 1106 is configured to determine a priority of the second transmission request. The yield determination module 1108 is configured to determine whether to Rx-yield the transmission request response based on the second transmission request when the second transmission request has a higher priority than the transmission request and the second transmission request has a strongest received power of transmission requests received from links with the second AP.

In one configuration, the connection scheduling communication module 1104 is configured to receive a third transmission request from a communication link with the second AP. The priority determination module 1106 is configured to determine a priority of the third transmission request. If the third transmission request also has a higher priority than the transmission request, the yield determination module 1108 is configured to determine which of the second transmission request and the third transmission request has the strongest received power. The yield determination module 1108 is configured to determine whether to Rx-yield the transmission request response based on one of the second transmission request or the third transmission request with the strongest received power.

In one configuration, the connection scheduling communication module 1104 is configured to receive a fourth transmission request from a communication link with a third AP. The third AP is one of the at least one other AP. The priority determination module 1106 is configured to determine a priority of the fourth transmission request. If the fourth transmission request has a higher priority than the transmission request, the yield determination module 1108 is configured to determine whether to Rx-yield the transmission request response based on a sum of a received power of the fourth transmission request and a strongest received power of the second transmission request or the third transmission request.

In one configuration, the connection scheduling communication module 1104 is configured to receive a second transmission request from a second UE in a communication link with the AP 1102. The yield determination module 1108 is configured not to take into account the second transmission request when determining whether to Rx-yield the transmission request response to the transmission request of the UE 1150. If the yield determination module 1108 determines not to Rx-yield the transmission request response to the UE 1150 and not to Rx-yield the transmission request response to the second UE, the connection scheduling communication module 1104 is configured to determine whether to transmit the transmission request response to the UE 1150 or to the second UE. When making such a determination, the connection scheduling communication module 1104 may take into account at least one of priorities of the respective transmission requests, a QoS subscribed by each of the UE 1150 and the second UE, or an estimated rate of the communication link with the UE 1150 and the second UE.

In a second embodiment, the connection scheduling communication module 1104 is configured to receive a transmission request response from a UE 1150 in a communication link with the AP 1102. The yield determination module 1108 is configured to determine whether to Tx-yield a data transmission to the UE 1150 based on one or more transmission requests responses received from at least one communication link with at least one other AP, but not from UEs in communication links with the AP 1102.

In one configuration, the connection scheduling communication module 1104 is configured to receive a second transmission request response from a second UE in a communication link with the AP 1102. The yield determination module 1108 is configured not to take into account the received second transmission request response when determining whether to Tx-yield the data transmission to the UE 1150.

In one configuration, the connection scheduling communication module 1104 is configured to transmit a transmission request to the UE 1150. The transmission request response is in response to the transmission request to the UE 1150. The connection scheduling communication module 1104 is configured to transmit a second transmission request to the second UE. The second transmission request response is in response to the second transmission request to the second UE. The transmission request may be transmitted to the UE 1150 at a first transmit power and the second transmission request may be transmitted to the second UE at a second transmit power different than the first transmit power. The connection scheduling communication module 1104 may be configured to determine the first transmit power based on a path loss to the UE 1150 and to determine the second transmit power based on a path loss to the second UE.

In one configuration, the data traffic determination and communication module 1110 may be configured to determining whether to transmit data to the UE 1150 or to the second UE upon determining not to Tx-yield the data transmission to the UE 1150 and not to Tx-yield the data transmission to the second UE. The data traffic determination and communication module 1110 may determine whether to transmit the data to the UE 1150 or the second UE based on at least one of priorities of the respective transmission request responses, a QoS subscribed by each of the UE 1150 and the second UE, or an estimated rate of the communication link with the UE 1150 and the second UE.

In one configuration, the connection scheduling communication module 1104 is configured to receive a second transmission request response from a communication link with a second AP. The second AP is one of the at least one other AP. The yield determination module 1108 is configured to determine whether to Tx-yield the data transmission based on the second transmission request response when the second transmission request has a higher priority than the transmission request.

The apparatus may include additional modules that perform each of the steps of the algorithm in the aforementioned flow charts of FIGS. 8, 9. As such, each step in the aforementioned flow charts of FIGS. 8, 9 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

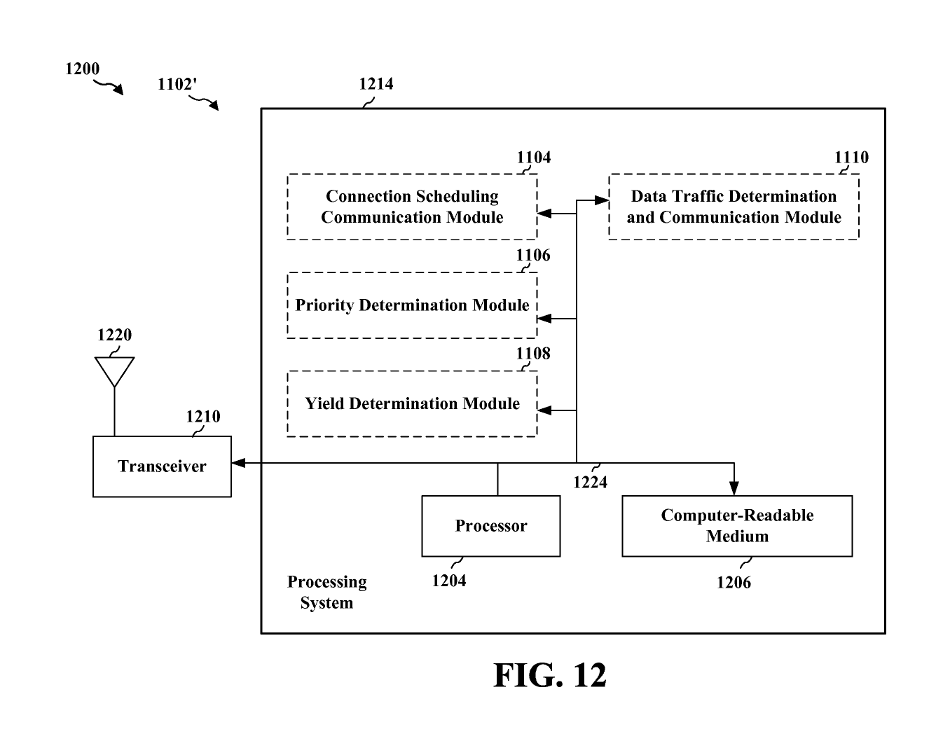

FIG. 12 is a diagram illustrating an example of a hardware implementation for an AP apparatus 1102′ employing a processing system 1214. The processing system 1214 may be implemented with a bus architecture, represented generally by the bus 1224. The bus 1224 may include any number of interconnecting buses and bridges depending on the specific application of the processing system 1214 and the overall design constraints. The bus 1224 links together various circuits including one or more processors and/or hardware modules, represented by the processor 1204, the modules 1104, 1106, 1108, 1110, and the computer-readable medium 1206. The bus 1224 may also link various other circuits such as timing sources, peripherals, voltage regulators, and power management circuits, which are well known in the art, and therefore, will not be described any further.

The processing system 1214 may be coupled to a transceiver 1210. The transceiver 1210 is coupled to one or more antennas 1220. The transceiver 1210 provides a means for communicating with various other apparatus over a transmission medium. The processing system 1214 includes a processor 1204 coupled to a computer-readable medium 1206. The processor 1204 is responsible for general processing, including the execution of software stored on the computer-readable medium 1206. The software, when executed by the processor 1204, causes the processing system 1214 to perform the various functions described supra for any particular apparatus. The computer-readable medium 1206 may also be used for storing data that is manipulated by the processor 1204 when executing software. The processing system further includes at least one of the modules 1104, 1106, 1108, and 1110. The modules may be software modules running in the processor 1204, resident/stored in the computer readable medium 1206, one or more hardware modules coupled to the processor 1204, or some combination thereof.

In one configuration, the apparatus 1102/1102′ for wireless communication includes means receiving a transmission request from a UE in a communication link with the AP. The apparatus further includes means for determining whether to yield a transmission request response to the transmission request based on one or more transmission requests received from at least one communication link with at least one other AP, but not from UEs in communication links with the AP. The apparatus may further include means for determining a priority of the transmission request; means for receiving a second transmission request from a communication link with a second AP, the second AP being one of the at least one other AP; and means for determining a priority of the second transmission request is higher than a priority of the transmission request. The means for determining whether to yield the transmission request response may make the determination based on the second transmission request when the second transmission request has a strongest received power of transmission requests received from links with the second AP. The apparatus may further include means for receiving a third transmission request from a communication link with the second AP, means for determining a priority of the third transmission request is higher than a priority of the transmission request, and means for determining which of the second transmission request and the third transmission request has the strongest received power. The means for determining whether to yield the transmission request response may make the determination based on one of the second transmission request or the third transmission request with the strongest received power. The apparatus may further include means for receiving a fourth transmission request from a communication link with a third AP, the third AP being one of the at least one other AP; and means for determining a priority of the fourth transmission request is higher than a priority of the transmission request. The means for determining whether to yield the transmission request response may make the determination based on a sum of a received power of the fourth transmission request and a strongest received power of the second transmission request or the third transmission request. The apparatus may further include means for receiving a second transmission request from a second UE in a communication link with the AP. The means for determining whether to yield the transmission request response to the transmission request of the UE may make the determination without taking into account the second transmission request. The apparatus may further include means for determining whether to transmit the transmission request response to the UE or to the second UE upon determining not to yield the transmission request response to the UE and not to yield the transmission request response to the second UE.

In one configuration, the apparatus 1102/1102′ for wireless communication includes means for receiving a transmission request response from a UE in a communication link with the AP. The apparatus further includes means for determining whether to yield a data transmission to the UE based on one or more transmission requests responses received from at least one communication link with at least one other AP, but not from UEs in communication links with the AP. The apparatus may further include means for receiving a second transmission request response from a second UE in a communication link with the AP. The means for determining whether to yield the data transmission to the UE may make the determination without taking into account the second transmission request response. The apparatus may further include means for transmitting a transmission request to the UE, the transmission request response being in response to the transmission request to the UE; and means for transmitting a second transmission request to the second UE, the second transmission request response being in response to the second transmission request to the second UE. The apparatus may further include means for determining the first transmit power based on a path loss to the UE, and means for determining the second transmit power based on a path loss to the second UE. The apparatus may further include means for determining whether to transmit data to the UE or to the second UE upon determining not to yield the data transmission to the UE and not to yield the data transmission to the second UE. The apparatus may further include means for receiving a second transmission request response from a communication link with a second AP. The second AP is one of the at least one other AP. The means for determining whether to yield the data transmission may make the determination based on the second transmission request response when the second transmission request has a higher priority than the transmission request. The aforementioned means may be one or more of the aforementioned modules of the apparatus 1102 and/or the processing system 1214 of the apparatus 1102′ configured to perform the functions recited by the aforementioned means.

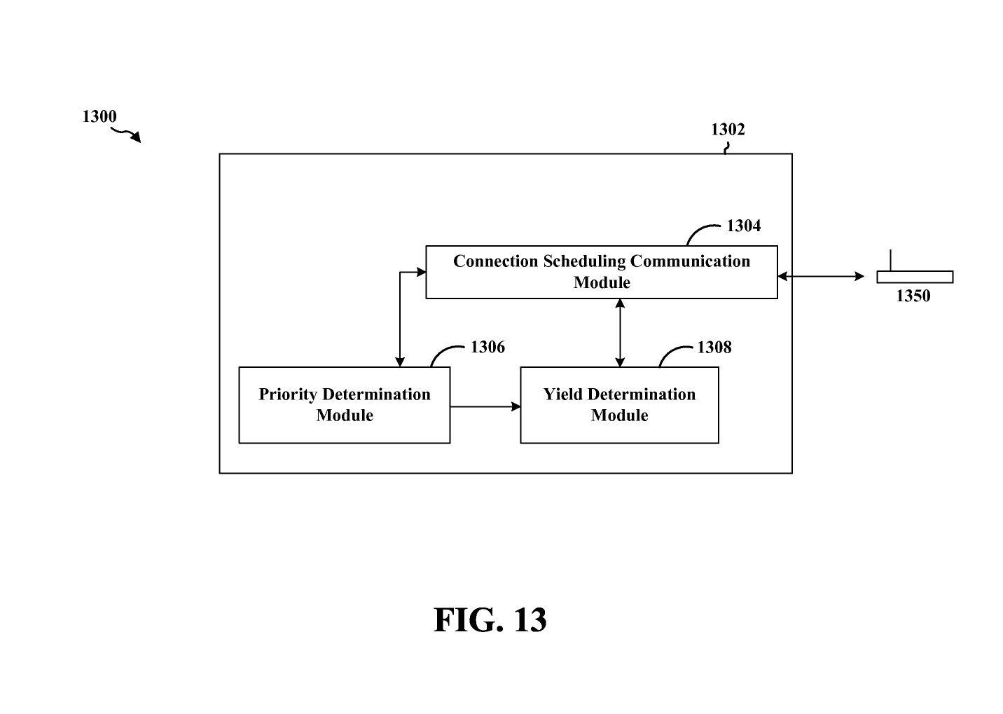

FIG. 13 is a conceptual data flow diagram 1300 illustrating the data flow between different modules/means/components in an exemplary UE apparatus 1302. The UE 1302 includes a connection scheduling communication module 1304, a priority determination module 1306, and a yield determination module 1308. The connection scheduling communication module 1304 is configured to receive a transmission request from an AP 1350. The yield determination module 1308 is configured to determine whether to Rx-yield a transmission request response to the transmission request based on one or more transmission requests received from at least one communication link with at least one other AP, but not from communication links with the AP 1350.

In one configuration, the connection scheduling communication module 1304 is configured to receive a second transmission request from the AP 1350. The second transmission request is for a second UE in a communication link with the AP 1350. The yield determination module 1308 is configured not to take into account the second transmission request when determining whether to yield the transmission request response.

In one configuration, the priority determination module 1306 is configured to determine a priority of the transmission request. The connection scheduling communication module 1304 is configured to receive a second transmission request from a communication link with a second AP. The second AP is one of the at least one other AP. The priority determination module 1306 is configured to determine a priority of the second transmission request. If the priority of the second transmission request is higher than a priority of the transmission request, the yield determination module 1308 is configured to determine whether to yield the transmission request response based on the second transmission request when the second transmission request has a strongest received power of transmission requests received from links with the second AP.

In one configuration, the connection scheduling communication module 1304 is configured to receive a third transmission request from a communication link with the second AP. The priority determination module 1306 is configured to determine a priority of the third transmission request. If the priority of the third transmission request is higher than a priority of the transmission request, the yield determination module 1308 is configured to determine which of the second transmission request and the third transmission request has the strongest received power to determine whether to yield the transmission request response based on one of the second transmission request or the third transmission request with the strongest received power.

In one configuration, the connection scheduling communication module 1304 is configured to receive a fourth transmission request from a communication link with a third AP. The third AP is one of the at least one other AP. The priority determination module 1306 is configured to determine a priority of the fourth transmission request. If the priority of the fourth transmission request is higher than a priority of the transmission request, the yield determination module 1308 is configured to determine whether to yield the transmission request response based on a sum of a received power of the fourth transmission request and a strongest received power of the second transmission request or the third transmission request.

The apparatus may include additional modules that perform each of the steps of the algorithm in the aforementioned flow chart of FIG. 10. As such, each step in the aforementioned flow chart of FIG. 10 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

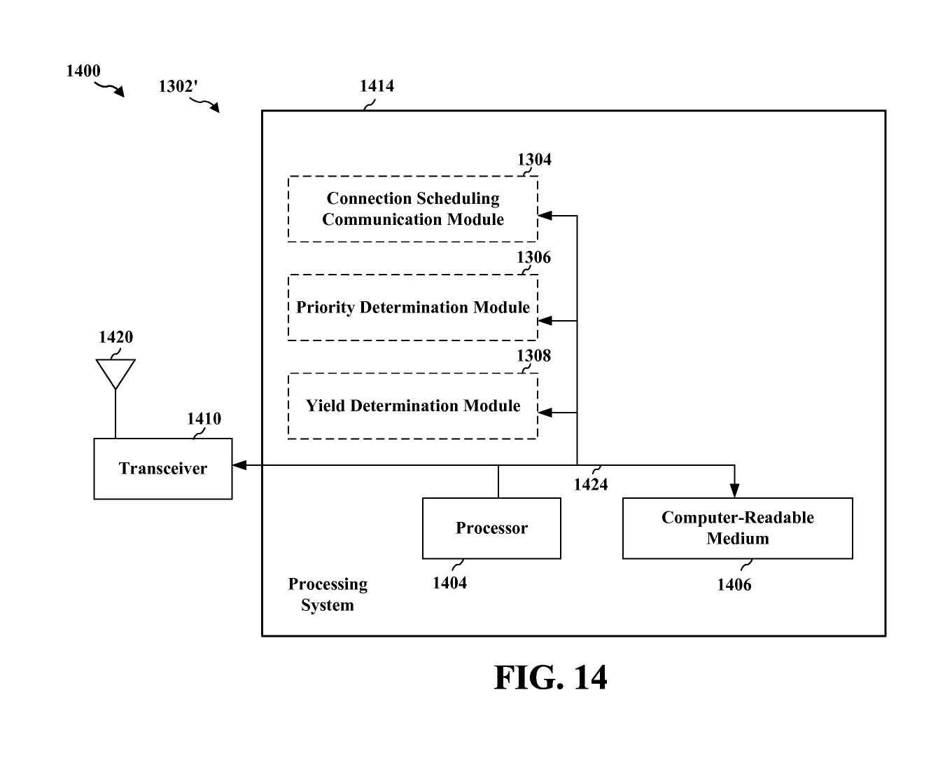

FIG. 14 is a diagram illustrating an example of a hardware implementation for a UE apparatus 1302′ employing a processing system 1414. The processing system 1414 may be implemented with a bus architecture, represented generally by the bus 1424. The bus 1424 may include any number of interconnecting buses and bridges depending on the specific application of the processing system 1414 and the overall design constraints. The bus 1424 links together various circuits including one or more processors and/or hardware modules, represented by the processor 1404, the modules 1304, 1306, 1308, 1310, and the computer-readable medium 1406. The bus 1424 may also link various other circuits such as timing sources, peripherals, voltage regulators, and power management circuits, which are well known in the art, and therefore, will not be described any further.

The processing system 1414 may be coupled to a transceiver 1410. The transceiver 1410 is coupled to one or more antennas 1420. The transceiver 1410 provides a means for communicating with various other apparatus over a transmission medium. The processing system 1414 includes a processor 1404 coupled to a computer-readable medium 1406. The processor 1404 is responsible for general processing, including the execution of software stored on the computer-readable medium 1406. The software, when executed by the processor 1404, causes the processing system 1414 to perform the various functions described supra for any particular apparatus. The computer-readable medium 1406 may also be used for storing data that is manipulated by the processor 1404 when executing software. The processing system further includes at least one of the modules 1304, 1306, 1308, and 1310. The modules may be software modules running in the processor 1404, resident/stored in the computer readable medium 1406, one or more hardware modules coupled to the processor 1404, or some combination thereof.

In one configuration, the apparatus 1302/1302′ for wireless communication includes means for receiving a transmission request from an AP. The apparatus further includes means for determining whether to yield a transmission request response to the transmission request based on one or more transmission requests received from at least one communication link with at least one other AP, but not from communication links with the AP. The apparatus may further include means for receiving a second transmission request from the AP. The second transmission request is for a second UE in a communication link with the AP. The means for determining whether to yield the transmission request response may make the determination without taking into account the second transmission request. The apparatus may further include means for determining a priority of the transmission request; means for receiving a second transmission request from a communication link with a second AP, the second AP being one of the at least one other AP; and means for determining a priority of the second transmission request is higher than a priority of the transmission request. The means for determining whether to yield the transmission request response may make the determination based on the second transmission request when the second transmission request has a strongest received power of transmission requests received from links with the second AP. The apparatus may further include means for receiving a third transmission request from a communication link with the second AP; means for determining a priority of the third transmission request is higher than a priority of the transmission request; and means for determining which of the second transmission request and the third transmission request has the strongest received power. The means for determining whether to yield the transmission request response may make the determination based on one of the second transmission request or the third transmission request with the strongest received power. The apparatus may further include means for receiving a fourth transmission request from a communication link with a third AP, the third AP being one of the at least one other AP; and means for determining a priority of the fourth transmission request is higher than a priority of the transmission request. The means for determining whether to yield the transmission request response may make the determination based on a sum of a received power of the fourth transmission request and a strongest received power of the second transmission request or the third transmission request. The aforementioned means may be one or more of the aforementioned modules of the apparatus 1302 and/or the processing system 1414 of the apparatus 1302′ configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication of an access point (AP), comprising:
receiving a transmission request from a user equipment (UE) in a communication link with the AP; and
determining whether to yield a transmission request response to the transmission request based on one or more transmission requests received from at least one communication link with at least one other AP, but not from UEs in communication links with the AP.

2. The method of claim 1, further comprising:
determining a priority of the transmission request;
receiving a second transmission request from a communication link with a second AP, the second AP being one of the at least one other AP; and
determining a priority of the second transmission request is higher than the priority of the transmission request,
wherein the determining whether to yield the transmission request response is based on the second transmission request when the second transmission request has a strongest received power of transmission requests received from links with the second AP that have higher priority than the priority of the transmission request.

3. The method of claim 2, further comprising:
receiving a third transmission request from a communication link with the second AP;
determining a priority of the third transmission request is higher than the priority of the transmission request; and
determining which of the second transmission request and the third transmission request has the strongest received power,
wherein the determining whether to yield the transmission request response is based on one of the second transmission request or the third transmission request with the strongest received power.

4. The method of claim 3, further comprising:
receiving a fourth transmission request from a communication link with a third AP, the third AP being one of the at least one other AP; and
determining a priority of the fourth transmission request is higher than the priority of the transmission request,
wherein the determining whether to yield the transmission request response is based on a sum of a received power of the fourth transmission request and a strongest received power of the second transmission request or the third transmission request.

5. The method of claim 1, further comprising receiving a second transmission request from a second UE in a communication link with the AP, wherein the determination whether to yield the transmission request response to the transmission request of the UE is not based on the second transmission request.

6. The method of claim 5, further comprising determining whether to transmit the transmission request response to the UE or to the second UE upon determining not to yield the transmission request response to the UE and not to yield the transmission request response to the second UE.

7. The method of claim 6, wherein the determination whether to transmit the transmission request response to the UE or the second UE is based on at least one of priorities of the respective transmission requests, a quality of service (QoS) subscribed by each of the UE and the second UE, or an estimated rate of the communication link with the UE and the second UE.

8. A method of wireless communication of an access point (AP), comprising:
receiving a transmission request response from a user equipment (UE) in a communication link with the AP; and
determining whether to yield a data transmission to the UE based on one or more transmission requests responses received from at least one communication link with at least one other AP, but not from UEs in communication links with the AP.

9. The method of claim 8, further comprising receiving a second transmission request response from a second UE in a communication link with the AP, wherein the determination whether to yield the data transmission to the UE is not based on the second transmission request response.

10. The method of claim 9, further comprising:
transmitting a transmission request to the UE, the transmission request response being in response to the transmission request to the UE; and
transmitting a second transmission request to the second UE, the second transmission request response being in response to the second transmission request to the second UE.

11. The method of claim 10, wherein the transmission request is transmitted to the UE at a first transmit power and the second transmission request is transmitted to the second UE at a second transmit power different than the first transmit power.

12. The method of claim 11, further comprising:
determining the first transmit power based on a path loss to the UE; and
determining the second transmit power based on a path loss to the second UE.

13. The method of claim 9, further comprising determining whether to transmit data to the UE or to the second UE upon determining not to yield the data transmission to the UE and not to yield the data transmission to the second UE.

14. The method of claim 13, wherein the determination whether to transmit the data to the UE or the second UE is based on at least one of priorities of the respective transmission request responses, a quality of service (QoS) subscribed by each of the UE and the second UE, or an estimated rate of the communication link with the UE and the second UE.

15. The method of claim 8, further comprising receiving a second transmission request response from a communication link with a second AP, the second AP being one of the at least one other AP, wherein the determining whether to yield the data transmission is based on the second transmission request response when the second transmission request has a higher priority than the transmission request.

16. A method of wireless communication of a user equipment (UE), comprising:
receiving a transmission request from an access point (AP); and
determining whether to yield a transmission request response to the transmission request based on one or more transmission requests received from at least one communication link with at least one other AP, but not from communication links with the AP.

17. The method of claim 16, further comprising receiving a second transmission request from the AP, the second transmission request being for a second UE in a communication link with the AP, wherein the determination whether to yield the transmission request response is not based on the second transmission request.

18. The method of claim 16, further comprising:
determining a priority of the transmission request;
receiving a second transmission request from a communication link with a second AP, the second AP being one of the at least one other AP; and
determining a priority of the second transmission request is higher than the priority of the transmission request,
wherein the determining whether to yield the transmission request response is based on the second transmission request when the second transmission request has a strongest received power of transmission requests received from links with the second AP that have higher priority than the priority of the transmission request.

19. The method of claim 18, further comprising:
receiving a third transmission request from a communication link with the second AP;
determining a priority of the third transmission request is higher than the priority of the transmission request; and
determining which of the second transmission request and the third transmission request has the strongest received power,
wherein the determining whether to yield the transmission request response is based on one of the second transmission request or the third transmission request with the strongest received power.

20. The method of claim 19, further comprising:
receiving a fourth transmission request from a communication link with a third AP, the third AP being one of the at least one other AP; and
determining a priority of the fourth transmission request is higher than the priority of the transmission request,
wherein the determining whether to yield the transmission request response is based on a sum of a received power of the fourth transmission request and a strongest received power of the second transmission request or the third transmission request.

21. An access point (AP) for wireless communication, comprising:
means for receiving a transmission request from a user equipment (UE) in a communication link with the AP; and
means for determining whether to yield a transmission request response to the transmission request based on one or more transmission requests received from at least one communication link with at least one other AP, but not from UEs in communication links with the AP.

22. The AP of claim 21, further comprising:
means for determining a priority of the transmission request;
means for receiving a second transmission request from a communication link with a second AP, the second AP being one of the at least one other AP; and
means for determining a priority of the second transmission request is higher than the priority of the transmission request,
wherein the means for determining whether to yield the transmission request response makes the determination based on the second transmission request when the second transmission request has a strongest received power of transmission requests received from links with the second AP that have higher priority than the priority of the transmission request.

23. The AP of claim 22, further comprising:
means for receiving a third transmission request from a communication link with the second AP;
means for determining a priority of the third transmission request is higher than the priority of the transmission request; and
means for determining which of the second transmission request and the third transmission request has the strongest received power,
wherein the means for determining whether to yield the transmission request response makes the determination based on one of the second transmission request or the third transmission request with the strongest received power.

24. The AP of claim 23, further comprising:
means for receiving a fourth transmission request from a communication link with a third AP, the third AP being one of the at least one other AP; and
means for determining a priority of the fourth transmission request is higher than the priority of the transmission request,
wherein the means for determining whether to yield the transmission request response makes the determination based on a sum of a received power of the fourth transmission request and a strongest received power of the second transmission request or the third transmission request.

25. The AP of claim 21, further comprising means for receiving a second transmission request from a second UE in a communication link with the AP, wherein the means for determining whether to yield the transmission request response to the transmission request of the UE makes the determination without taking into account the second transmission request.

26. The AP of claim 25, further comprising means for determining whether to transmit the transmission request response to the UE or to the second UE upon determining not to yield the transmission request response to the UE and not to yield the transmission request response to the second UE.

27. The AP of claim 26, wherein the means for determining whether to transmit the transmission request response to the UE or the second UE makes the determination based on at least one of priorities of the respective transmission requests, a quality of service (QoS) subscribed by each of the UE and the second UE, or an estimated rate of the communication link with the UE and the second UE.

28. An access point (AP) for wireless communication, comprising:
means for receiving a transmission request response from a user equipment (UE) in a communication link with the AP; and
means for determining whether to yield a data transmission to the UE based on one or more transmission requests responses received from at least one communication link with at least one other AP, but not from UEs in communication links with the AP.

29. The AP of claim 28, further comprising means for receiving a second transmission request response from a second UE in a communication link with the AP, wherein the means for determining whether to yield the data transmission to the UE makes the determination without taking into account the second transmission request response.

30. The AP of claim 29, further comprising:
means for transmitting a transmission request to the UE, the transmission request response being in response to the transmission request to the UE; and
means for transmitting a second transmission request to the second UE, the second transmission request response being in response to the second transmission request to the second UE.

31. The AP of claim 30, wherein the transmission request is transmitted to the UE at a first transmit power and the second transmission request is transmitted to the second UE at a second transmit power different than the first transmit power.

32. The AP of claim 31, further comprising:
means for determining the first transmit power based on a path loss to the UE; and
means for determining the second transmit power based on a path loss to the second UE.

33. The AP of claim 29, further comprising means for determining whether to transmit data to the UE or to the second UE upon determining not to yield the data transmission to the UE and not to yield the data transmission to the second UE.

34. The AP of claim 33, wherein the means for determining whether to transmit the data to the UE or the second UE makes the determination based on at least one of priorities of the respective transmission request responses, a quality of service (QoS) subscribed by each of the UE and the second UE, or an estimated rate of the communication link with the UE and the second UE.

35. The AP of claim 28, further comprising means for receiving a second transmission request response from a communication link with a second AP, the second AP being one of the at least one other AP, wherein the means for determining whether to yield the data transmission makes the determination based on the second transmission request response when the second transmission request has a higher priority than the transmission request.

36. A user equipment (UE) for wireless communication, comprising:
means for receiving a transmission request from an access point (AP); and
means for determining whether to yield a transmission request response to the transmission request based on one or more transmission requests received from at least one communication link with at least one other AP, but not from communication links with the AP.

37. The UE of claim 36, further comprising means for receiving a second transmission request from the AP, the second transmission request being for a second UE in a communication link with the AP, wherein the means for determining whether to yield the transmission request response makes the determination without taking into account the second transmission request.

38. The UE of claim 36, further comprising:
means for determining a priority of the transmission request;
means for receiving a second transmission request from a communication link with a second AP, the second AP being one of the at least one other AP; and
means for determining a priority of the second transmission request is higher than the priority of the transmission request,
wherein the means for determining whether to yield the transmission request response makes the determination based on the second transmission request when the second transmission request has a strongest received power of transmission requests received from links with the second AP that have higher priority than the priority of the transmission request.

39. The UE of claim 38, further comprising:
means for receiving a third transmission request from a communication link with the second AP;
means for determining a priority of the third transmission request is higher than the priority of the transmission request; and
means for determining which of the second transmission request and the third transmission request has the strongest received power,
wherein the means for determining whether to yield the transmission request response makes the determination based on one of the second transmission request or the third transmission request with the strongest received power.

40. The UE of claim 39, further comprising:
means for receiving a fourth transmission request from a communication link with a third AP, the third AP being one of the at least one other AP; and
means for determining a priority of the fourth transmission request is higher than the priority of the transmission request,
wherein the means for determining whether to yield the transmission request response makes the determination based on a sum of a received power of the fourth transmission request and a strongest received power of the second transmission request or the third transmission request.

41. An access point (AP) for wireless communication, comprising:
a processing system configured to:
receive a transmission request from a user equipment (UE) in a communication link with the AP; and
determine whether to yield a transmission request response to the transmission request based on one or more transmission requests received from at least one communication link with at least one other AP, but not from UEs in communication links with the AP.

42. The AP of claim 41, wherein the processing system is further configured to:
determine a priority of the transmission request;
receive a second transmission request from a communication link with a second AP, the second AP being one of the at least one other AP; and
determine a priority of the second transmission request is higher than the priority of the transmission request,
wherein the processing system is configured to determine whether to yield the transmission request response based on the second transmission request when the second transmission request has a strongest received power of transmission requests received from links with the second AP that have higher priority than the priority of the transmission request.

43. The AP of claim 42, wherein the processing system is further configured to:
receive a third transmission request from a communication link with the second AP;
determine a priority of the third transmission request is higher than the priority of the transmission request; and
determine which of the second transmission request and the third transmission request has the strongest received power,
wherein the processing system is configured to determine whether to yield the transmission request response based on one of the second transmission request or the third transmission request with the strongest received power.

44. The AP of claim 43, wherein the processing system is further configured to:
receive a fourth transmission request from a communication link with a third AP, the third AP being one of the at least one other AP; and
determine a priority of the fourth transmission request is higher than the priority of the transmission request,
wherein the processing system is configured to determine whether to yield the transmission request response based on a sum of a received power of the fourth transmission request and a strongest received power of the second transmission request or the third transmission request.

45. The AP of claim 41, wherein the processing system is further configured to receive a second transmission request from a second UE in a communication link with the AP, wherein the processing system is configured to determine whether to yield the transmission request response to the transmission request of the UE without taking into account the second transmission request.

46. The AP of claim 45, wherein the processing system is further configured to determine whether to transmit the transmission request response to the UE or to the second UE upon determining not to yield the transmission request response to the UE and not to yield the transmission request response to the second UE.

47. The AP of claim 46, wherein the processing system is configured to determine whether to transmit the transmission request response to the UE or the second UE based on at least one of priorities of the respective transmission requests, a quality of service (QoS) subscribed by each of the UE and the second UE, or an estimated rate of the communication link with the UE and the second UE.

48. An access point (AP) for wireless communication, comprising:
a processing system configured to:
receive a transmission request response from a user equipment (UE) in a communication link with the AP; and
determine whether to yield a data transmission to the UE based on one or more transmission requests responses received from at least one communication link with at least one other AP, but not from UEs in communication links with the AP.

49. The AP of claim 48, wherein the processing system is further configured to receive a second transmission request response from a second UE in a communication link with the AP, wherein the processing system is configured to determine whether to yield the data transmission to the UE without taking into account the second transmission request response.

50. The AP of claim 49, wherein the processing system is further configured to:
transmit a transmission request to the UE, the transmission request response being in response to the transmission request to the UE; and
transmit a second transmission request to the second UE, the second transmission request response being in response to the second transmission request to the second UE.

51. The AP of claim 50, wherein the transmission request is transmitted to the UE at a first transmit power and the second transmission request is transmitted to the second UE at a second transmit power different than the first transmit power.

52. The AP of claim 51, wherein the processing system is further configured to:
determine the first transmit power based on a path loss to the UE; and
determine the second transmit power based on a path loss to the second UE.

53. The AP of claim 49, wherein the processing system is further configured to determine whether to transmit data to the UE or to the second UE upon determining not to yield the data transmission to the UE and not to yield the data transmission to the second UE.

54. The AP of claim 53, wherein the processing system is configured to determine whether to transmit the data to the UE or the second UE based on at least one of priorities of the respective transmission request responses, a quality of service (QoS) subscribed by each of the UE and the second UE, or an estimated rate of the communication link with the UE and the second UE.

55. The AP of claim 48, wherein the processing system is further configured to receive a second transmission request response from a communication link with a second AP, the second AP being one of the at least one other AP, wherein the processing system is configured to determine whether to yield the data transmission based on the second transmission request response when the second transmission request has a higher priority than the transmission request.

56. A user equipment (UE) for wireless communication, comprising:
a processing system configured to:
receive a transmission request from an access point (AP); and
determine whether to yield a transmission request response to the transmission request based on one or more transmission requests received from at least one communication link with at least one other AP, but not from communication links with the AP.

57. The UE of claim 56, wherein the processing system is further configured to receive a second transmission request from the AP, the second transmission request being for a second UE in a communication link with the AP, wherein the processing system is configured to determine whether to yield the transmission request response without taking into account the second transmission request.

58. The UE of claim 56, wherein the processing system is further configured to:
determine a priority of the transmission request;
receive a second transmission request from a communication link with a second AP, the second AP being one of the at least one other AP; and
determine a priority of the second transmission request is higher than the priority of the transmission request,
wherein the processing system is configured to determine whether to yield the transmission request response based on the second transmission request when the second transmission request has a strongest received power of transmission requests received from links with the second AP that have higher priority than the priority of the transmission request.

59. The UE of claim 58, wherein the processing system is further configured to:
receive a third transmission request from a communication link with the second AP;
determine a priority of the third transmission request is higher than the priority of the transmission request; and
determine which of the second transmission request and the third transmission request has the strongest received power,
wherein the processing system is configured to determine whether to yield the transmission request response based on one of the second transmission request or the third transmission request with the strongest received power.

60. The UE of claim 59, wherein the processing system is further configured to:
receive a fourth transmission request from a communication link with a third AP, the third AP being one of the at least one other AP; and
determine a priority of the fourth transmission request is higher than the priority of the transmission request,
wherein the processing system is configured to determine whether to yield the transmission request response based on a sum of a received power of the fourth transmission request and a strongest received power of the second transmission request or the third transmission request.

61. A computer program product of an access point (AP), comprising:
a computer-readable medium comprising code for:
receiving a transmission request from a user equipment (UE) in a communication link with the AP; and
determining whether to yield a transmission request response to the transmission request based on one or more transmission requests received from at least one communication link with at least one other AP, but not from UEs in communication links with the AP.

62. A computer program product of an access point (AP), comprising:
a computer-readable medium comprising code for:
receiving a transmission request response from a user equipment (UE) in a communication link with the AP; and
determining whether to yield a data transmission to the UE based on one or more transmission requests responses received from at least one communication link with at least one other AP, but not from UEs in communication links with the AP.

63. A computer program product of a user equipment (UE), comprising:
a computer-readable medium comprising code for:
receiving a transmission request from an access point (AP); and
determining whether to yield a transmission request response to the transmission request based on one or more transmission requests received from at least one communication link with at least one other AP, but not from communication links with the AP.
